(19) United States
(12) Patent Application Publication
(10) Pub. No.: US 2024/0145817 A1
(43) Pub. Date: May 2, 2024

(54) ENERGY STORAGE DEVICE HAVING COOLING DEVICE FOR INDIRECT COOLING OF MODULE CONNECTORS AND METHOD FOR COOLING CELL GROUPS OF AN ENERGY STORAGE DEVICE

(71) Applicant: AUDI AG, Ingolstadt (DE)

(72) Inventors: Wolfgang BECK, Aichach (DE); Johannes HAF, Neuburg (DE)

(73) Assignee: AUDI AG, Ingolstadt (DE)

(21) Appl. No.: 18/496,098

(22) Filed: Oct. 27, 2023

(30) Foreign Application Priority Data
Oct. 31, 2022 (DE) 102022128806.4

(51) Int. Cl. H01M 10/6567; H01M 10/651; H01M 50/502

(52) U.S. Cl. CPC H01M 10/6567; H01M 10/651; H01M 50/502; H01M 10/613

(57) ABSTRACT

An energy storage device having a first and second cell group and having a cooling device for cooling the cell groups. The energy storage device has a module connector, which electrically conductively connects a cell pole of a first battery cell of the first cell group and a cell pole of a second battery cell of the second cell group to one another. The cooling device has a cooling plate arrangement having a first cooling unit through which a coolant can flow and which is arranged on a respective first side of the first and second cell groups. The cooling device has a distributor arrangement which has at least one supply connection fluidically coupled to the first cooling unit and at least one discharge connection.

### FIELD

The invention relates to an energy storage device having a first and second cell group and having a cooling device for cooling at least the first and second cell groups. The energy storage device has a first energy storage arrangement which comprises the first and second cell groups, which in turn each have a first side and a second side opposite to the first side with respect to a first direction. The first and second cell groups are arranged adjacent to one another with respect to a second direction and the first cell group has a first end region with respect to a third direction, in which a first battery cell of the first cell group is arranged, which has a first cell pole and a second cell pole, wherein the second cell pole is closer to the second cell group than the first cell pole. Furthermore, the second cell group has a second end region with respect to the third direction, in which a second battery cell of the second cell group is arranged, which has a first cell pole and a second cell pole, wherein the second cell pole of the second battery cell of the first cell group is closer than the first cell pole of the second battery cell. The first end region is located adjacent to the second end region in relation to the second direction. Furthermore, the first energy storage arrangement has a module connector which electrically conductively connects the second cell pole of the first battery cell and the second cell pole of the second battery cell to one another, wherein the cooling device, as part of the first energy storage arrangement, has a cooling arrangement having a first cooling unit through which a coolant can flow, which has is arranged on the first sides of the first and second cell groups, wherein the cooling device has a distributor arrangement which has at least one supply connection fluidically coupled to the first cooling unit for supplying a coolant to the first cooling unit and at least one discharge connection fluidically coupled to the first cooling unit for discharging the coolant supplied to the first cooling unit from the first cooling unit.

### BACKGROUND

A cell group can be understood to mean, for example, a battery module. Such battery modules can be arranged adjacent to one another and their upper sides or lower sides can be cooled using a plate-shaped cooling device through which a coolant, for example water, can flow. The coolant is typically supplied to such a cooling plate via at least one supply connection and discharged again via a discharge connection. In particular, several such supply and discharge connections can also be provided here. The coolant typically travels a certain distance from the supply connection to the discharge connection, via which the coolant is discharged from the cooling plate again. As a result, the coolant heats up. When designing such cooling devices, in principle, efforts are always taken to cool the battery modules or battery cells to be cooled as uniformly and homogeneously as possible. It has to be taken into consideration here that the coolant supplied via a supply connection can typically be significantly cooler than the coolant ultimately discharged from the discharge connection, which has heated up in the meantime. Depending on the course of the cooling channels between this supply connection and the discharge connection, regions of the energy storage device thus result which may possibly be cooled to a greater or lesser extent.

DE 10 2015 217 790 A1 describes an arrangement for cooling battery cells, wherein poles of at least two battery cells are interconnected via at least one cell connector. In this case, on a side of the at least one cell connector opposite to the battery cell, a cooling device is arranged in a thermally conductive connection and electrically insulating connection to the at least one cell connector.

Furthermore, DE 10 2013 015 422 A1 describes a cooling device for cooling battery cells using a heat exchanger element for thermal connection to a battery cell for conducting heat from the battery cell to the surroundings. In addition, the cooling device comprises a cooling medium supply device arranged separately from the heat exchanger element for supplying a cooling medium to the heat exchanger element. The heat exchanger element is connected to the battery cell via a connection pole. Furthermore, the heat exchanger element is formed having a cell connector and can have ribs and/or tabs. A non-conductive and chemically inert cooling medium is also used as the cooling medium.

### SUMMARY

The object of the present invention is to provide an energy storage device and a method which make it possible to provide the most homogeneous possible cooling of cell groups in the simplest possible manner.

An energy storage device according to the invention comprises a first and a second cell group and a cooling device for cooling at least the first and second cell group. The energy storage device has a first energy storage arrangement which comprises the first and second cell groups, which in turn each have a first side and a second side opposite to the first side with respect to a first direction.

The first and the second cell groups are arranged adjacent to one another with respect to a second direction and the first cell group has a first end region with respect to a third direction, in which a first battery cell of the first cell group is arranged, which has a first cell pole and a second cell pole, wherein the second cell pole of the second cell group is closer than the first cell pole. Furthermore, the second cell group has a second end region with respect to the third direction, in which a second battery cell of the second cell group is arranged, which has a first cell pole and a second cell pole, wherein the second cell pole of the second battery cell of the first cell group is closer than the first cell pole of the second battery cell. The first end region is located adjacent to the second end region in relation to the second direction. Furthermore, the first energy storage arrangement has a module connector which electrically conductively connects the second cell pole of the first battery cell and the second cell pole of the second battery cell to one another, wherein the cooling device, as part of the first energy storage arrangement, has a cooling arrangement having a first cooling unit through which a coolant can flow, which has is arranged on the first sides of the first and second cell groups, wherein the cooling device has a distributor arrangement which has at least one supply connection fluidically coupled to the first cooling unit for supplying a coolant to the first cooling unit and at least one discharge connection fluidically coupled to the first cooling unit for discharging the coolant supplied to the first cooling unit from the first cooling unit. The first cooling unit now has a first cooling region, which is assigned to the first cell group and which is divided with respect to the second direction into a first subregion through which the coolant can flow and a second subregion through which the coolant can flow. In addition, the first cooling unit comprises a third cooling region, which is assigned to the second cell group, and which is divided with respect to the second direction into a first subregion through which the coolant can flow and a second subregion through which the coolant can flow, wherein the two second subregions are arranged between the two first subregions relative to the second direction and are coupled to the at least one supply connection, and the two first subregions are coupled to the at least one discharge connection, so that the second subregions are located closer to the at least one supply connection than the first subregions with respect to an intended flow direction.

The invention is based here on the finding that a very large amount of waste heat arises in particular in the region of module connectors. Furthermore, the invention is based on the finding that direct cooling of such a module connector, for example via a specially provided cooling device, is inefficient, since such a current-carrying module connector would have to be appropriately insulated from such a cooling device, which extremely reduces the efficiency of the heat transfer from the module connector to such a cooling device. The heat arising in the module connector would therefore be transferred only slightly or not at all to the cooling system, but rather would be introduced into the battery cells via the cell poles. The use of non-conductive or chemically inert cooling media also reduces the cooling efficiency and/or the cooling becomes extremely expensive. Furthermore, the invention uses the finding that by skilled positioning of the supply and discharge connections of the first cooling unit, which is arranged on the first sides of the two cell groups to cool them, it is possible to at least partially compensate for the increased heat input into the cells through the module connector. As described at the outset, a coolant supplied to the supply connection, before it has passed through the first cooling unit, is significantly cooler than after it has passed through the cooling unit and when it is discharged via the discharge connection. Due to the design of the energy storage device described above, the supply and discharge connection is now positioned in such a way that the second poles of the first and second battery cells in the two end regions of the cell groups can be cooled more strongly than the respective first two poles of these two battery cells by the described cooling plate arrangement. Since the second poles are now electrically connected to one another via the module connector, the described effect of the increased cooling of the second poles is at least partially compensated for by the increased heat input through the module connector or vice versa, the increased heat input into the second poles, due to the module connector, can be at least partially compensated for by the increased cooling of these two second poles in relation to the first poles. This advantageously contributes to the fact that a significantly more homogeneous temperature distribution can be set across the battery cells. Inhomogeneities in the cooling power distribution can therefore advantageously be used to at least partially compensate for inhomogeneities in the heat input into the cells caused by existing module connectors. This means that module connectors can advantageously be thermodynamically integrated into the cooling concept in order to achieve more homogeneous cooling of the cells overall.

The fact that the module connector connects the second cell pole of the first battery cell and the second cell pole of the second battery cell to one another in an electrically conductive manner is to be understood to mean that no further battery cell is arranged or interposed in this electrically conductive connection. A respective cell group comprises at least one battery cell, but preferably multiple battery cells. These can basically be designed in any way, for example as round cells, pouch cells, or prismatic cells. However, within the scope of the invention, a design as prismatic cells or pouch cells is preferred. In addition, the battery cells can be designed as lithium-ion cells, for example. The energy storage device can be designed as a battery. The energy storage device is preferably designed as a high-voltage energy storage device, in particular as a high-voltage battery.

One cell group can comprise multiple battery cells, which are arranged adjacent to one another in a stacking direction. This stacking direction corresponds to the above-mentioned third direction. Incidentally, the above-mentioned first, second, and third directions can be perpendicular to one another, that is to say the first direction is perpendicular to the second and third directions and the second direction is also perpendicular to the third direction. The first direction preferably corresponds to a vehicle vertical direction in relation to an intended installation position of the energy storage device in a motor vehicle. The first cooling unit can, for example, represent an upper or lower cooling plate. If the first cooling unit is designed, for example, as an upper cooling plate, it can be provided, for example, by a housing cover of a battery housing of the energy storage device, in which the cell groups are arranged. If the cooling unit is designed, for example, as a lower cooling plate, it can be provided, for example, by a bottom of such a battery housing. However, the first cooling unit can also be provided as a separate component, that is to say it can be formed separately from a housing base and/or housing cover. Furthermore, the first cooling unit can be designed so that it simultaneously covers all of the first and second cell groups of the energy storage device, and possibly the cells of optional further cell groups comprised by the energy storage device. Accordingly, the cells of the first and second cell groups can all be arranged in one plane. The cooling unit thus does not extend between the cells or between rows of cells. The first cooling unit, and in particular also the second cooling unit described in more detail later, can accordingly be designed to be essentially flat, for example as a cooling plate, wherein the cooling channels can represent slight elevations relative to this plane. The side of the first cooling unit facing toward the cells is preferably formed flat or even and without elevations. This simplifies the thermal connection to the battery cells.

The first and second cell groups can define a battery module as described. The energy storage device can not only have two such battery modules, but also, for example, more than two battery modules, for example three or four battery modules. These are then arranged relative to one another in such a way that their respective stacking directions extend parallel to one another, in particular in the third direction defined above, and the battery modules themselves can all be arranged adjacent to one another with respect to the second direction. Optionally, multiple battery modules can also be arranged adjacent to one another in the third direction, but preferably not in the first direction. This means that a common first cooling unit can advantageously be used for cooling these battery modules for multiple battery modules. The first cooling unit can therefore, for example, provide a common housing cover or a common housing bottom for the multiple battery modules. This allows an enormous amount of installation space to be saved and the design of the cooling device is greatly simplified. Furthermore, the two cell poles of a respective battery cell can in principle be arranged on any side of such a battery cell, but preferably not on the sides of the battery cells that delimit them in or counter to the third direction. Furthermore, the cell poles can be arranged on the same side of a respective battery cell, for example the first and second cell poles on the same side of the first battery cell or the second battery cell, or also on different sides. It is preferred that the two cell poles of a respective battery cell of a cell group are also arranged on opposite sides of the battery cell with respect to the second direction. The second cell pole of the first battery cell thus faces toward the second cell pole of the second battery cell, while the two first cell poles of the first and second battery cells are arranged on the respective cell sides, facing away from one another. The two second cell poles, which are electrically conductively connected to one another via the module connector, are preferably designed having opposite poles, that is, one of them is designed as a positive pole and the other as a negative pole. This allows the two cell groups to be connected in series using the module connector. A cell group or a cell module can, for example, be defined in that a cell module comprises all battery cells arranged adjacent to one another in the third direction. It can also be defined in such a way that the battery cells assigned to the same cell module or the same cell group are clamped together by a common clamping device, for example a module housing or a clamping frame. A module connector is understood to mean an electrically conductive element by means of which two different battery modules, in this case the two cell groups, are electrically conductively connected to one another. Such a module connector is to be distinguished from a cell connector, by means of which the individual battery cells of the same battery module or the same cell group are electrically conductively connected to one another and electrically interconnected. The cell poles can also be referred to as cell pole taps or terminals.

As described, the cell poles are preferably not arranged at the top or bottom of the cell in question, which significantly simplifies the upper-side and/or lower-side arrangement of a respective cooling unit. This makes it possible, above all, to cool the respective cell groups on both sides, as explained in more detail later. The fact that the two second subregions are located closer to the at least one supply connection in the intended flow direction than the first two subregions refers to the intended flow direction, which extends from the at least one supply connection to the at least one discharge connection along the cooling channels or cooling channel sections provided by the respective subregions. During normal operation of the cooling device, when the coolant is supplied to and discharged from the first cooling unit as intended, the first subregions are, for example, arranged downstream of the second subregions. In other words, during normal operation of the energy storage device, in particular its cooling device, the coolant is initially supplied to the second subregions via the supply connection and only after passing through the respective second subregions it reaches the first subregions and leaves them again via the at least one discharge connection. The terms “downstream” and “upstream” generally refer to the direction of flow of the coolant during normal operation of the cooling device. The two subregions can be directly coupled to the at least one supply connection, that is, connected directly thereto. The distributor arrangement can also have multiple supply connections, wherein the two second subregions can each be coupled to one of these multiple supply connections or can be connected directly thereto. The two first subregions, on the other hand, are not connected directly to the supply connection of the distributor arrangement, but rather only indirectly via the second subregions of the cooling plate arrangement. On the other hand, it is preferred that the two first subregions are directly and immediately coupled to the at least one discharge connection or are connected thereto. It is in turn conceivable in this case that the distributor arrangement has multiple such separate discharge connections and the two first subregions are each coupled to one such discharge connection and are connected directly thereto. However, it is also conceivable that the two first subregions are connected to a common discharge connection and/or the two second subregions are connected to a common supply connection. In this case, the cooling device is designed as described in such a way that when a coolant is supplied via the at least one supply connection to the cooling plate arrangement, it first enters and flows through the two second subregions before it enters the respective two first subregions and flows through them and again is discharged therefrom through the at least one discharge connection.

In principle, it is also possible to heat the battery cells by means of the cooling device instead of cooling them. In general, the cooling device can be used to control the temperature of the battery cells. If the cooling device is described below primarily with regard to its cooling function, the embodiments described above and described in more detail below can also be transferred analogously to a heating function executable by the cooling device.

The coolant can be, for example, water or a water-based coolant, for example water with glycol and/or other additives for the purpose of antifreeze or the like, for example. In principle, other coolants are also conceivable, generally liquid or gaseous coolants, wherein a liquid coolant is preferred due to its more efficient cooling effect.

The first battery cell represents an edge cell of the first cell group and the second battery cell represents an edge cell of the second cell group. The first and second battery cells are therefore the respective first or last battery cells of the cell group in relation to the third direction.

In a further advantageous embodiment of the invention, the cooling plate arrangement has a second cooling unit through which a coolant can flow and which is arranged on the second sides of the first and second cell group. This means that the second sides of the respective cell groups can also be cooled in an advantageous manner. In general, the second cooling unit can be designed as described for the first cooling unit, in particular with regard to its structural features and characteristics. The second cooling unit can also be designed as a cooling plate, in particular as an upper or lower cooling plate based on the intended installation position in a motor vehicle. This can also be provided either as a housing cover or housing bottom or as a separate component. Likewise, the second cooling unit can have cooling channels through which a coolant can flow. The side of the second cooling unit facing toward the cell groups is also preferably designed to be flat, which simplifies the thermal connection to the cells. The side of the second cooling unit facing away from the cells can be partially formed using protruding channel walls of the cooling channels. Cooling of the two cell groups on both sides can thus advantageously be provided.

In a further very advantageous embodiment of the invention, the second cooling unit has a second cooling region which is assigned to the first cell group and which is divided in relation to the second direction into a third subregion through which the coolant can flow and a fourth subregion through which the coolant can flow, wherein the first subregion of the first cooling region is opposite to the third subregion with respect to the first direction and the second subregion of the first cooling region is opposite the fourth subregion with respect to the first direction, wherein the second and third subregions are coupled to the at least one supply connection and the first and fourth subregions are coupled to the at least one discharge connection, so that the second and third subregions are located closer to the at least one supply connection in the flow direction than the first and fourth subregions. In relation to the first cooling region, the first subregion and the third subregion are thus opposite to one another in relation to the first direction, as are the second subregion and the fourth subregion. In other words, the first subregion and the fourth subregion are arranged diagonally to one another, as are the second subregion and the third subregion. The second and third subregions are connected directly to the supply connection, or optionally also to multiple different supply connections provided by the distributor arrangement, while the first and fourth subregions, on the other hand, are connected directly to the discharge connection or to multiple separate discharge connections provided by the distributor arrangement. As a result, a type of cross-flow can advantageously be achieved. This results in further homogenization of the temperature distribution within the cells. The two subregions of the first and second cooling units that are directly opposite with respect to the first direction are thus not coupled to the supply connection or the discharge connection, but rather the subregions arranged diagonally to one another. This makes it possible, above all, to provide a significantly more homogeneous temperature distribution with respect to the second direction.

The same principle can also be implemented for the second cell group. Accordingly, it represents a further very advantageous embodiment of the invention if the second cooling unit has a fourth cooling region which is assigned to the second cell group and which is divided with respect to the second direction into a third subregion through which the coolant can flow and a fourth subregion through which the coolant can flow, wherein the first subregion of the third cooling region with respect to the first direction is opposite to the third subregion of the fourth cooling region and the second subregion of the third cooling region with respect to the first direction is opposite to the fourth subregion of the fourth cooling region. The second subregion of the third cooling region and the third subregion of the fourth cooling region are coupled to the at least one supply connection, in particular again directly connected thereto, and the first subregion of the third cooling region and the fourth subregion of the fourth cooling region are coupled to the at least one discharge connection, in particular directly connected thereto, so that the second and third subregions are located closer to the at least one supply connection in the flow direction than the first and fourth subregions. This can also advantageously achieve cross-flow in relation to the second cell group. The subregions through which the coolant flows first and last, which are arranged directly on the second cell group, are also again diagonally opposite to one another here. This allows a particularly good temperature balance to be achieved.

It is particularly advantageous here above all if the second cooling unit, in particular per cell group, has a lower cooling capacity than the first cooling unit, in particular per cell group. A lower cooling capacity can be expressed or achieved, for example, by a lower flow rate of the coolant flowing through the respective cooling unit. A lower flow rate can in turn, for example, be provided by a smaller flow cross section. In other words, for example, the flow cross section provided by the second cooling unit per cell group can be smaller than the flow cross section provided by the first cooling unit per cell group, in particular with respect to a cross-sectional plane perpendicular to the third direction. The first cooling unit can therefore be a primary cooling unit and the second cooling unit can be a secondary cooling unit, which is intended to express that a slightly lower cooling capacity can be provided by the second cooling unit. This is particularly advantageous because the second subregions of the primary cooling unit, which are supplied directly from the at least one supply connection, are arranged closer to the second cell poles, which are electrically connected to one another via the module connector. In other words, the described arrangement of the respective subregions and their positioning with regard to the supply and discharge connections ensure that the second poles in the end region are basically cooled somewhat better than the first poles. The cooling device is therefore designed in such a way that improved cooling performance is provided precisely where the module connector is located, namely in the region of the second poles or electrically connecting them. Heat is then increasingly introduced precisely into the second poles of the first and second battery cells through the module connector. This can now be advantageously compensated for by the improved cooling performance, especially in the area of these second poles. Overall, this can provide a particularly homogeneous temperature control of the battery cells, which can also take local hotspot regions into consideration, for example, in the region of the module connectors.

In a further advantageous embodiment of the invention, the energy storage device has a second energy storage arrangement, which is designed like the first energy storage arrangement and is arranged in the second direction adjacent to the first energy storage arrangement. A particularly homogeneous temperature control of the respective battery cells can therefore be provided for a respective energy storage arrangement. The cooling units, for example the first cooling units of the two energy storage arrangements, can be manufactured as separate components or as a common component. This applies accordingly to the second cooling units. In addition, the first cooling unit and the second cooling unit as such can also be constructed from multiple separate cooling plates, for example one cooling plate per cooling region, namely one for the first cooling region, one for the second cooling region, one for the third cooling region, and one for the fourth cooling region. However, the first and third cooling regions can also be provided by a common cooling plate, as can the second and fourth cooling regions. The two energy storage arrangements also preferably use a common distributor arrangement. For the supply and discharge of the coolant to the respective cooling regions, the distributor arrangement can have multiple supply and discharge connections.

In a further advantageous embodiment of the invention, a respective first subregion is fluidically connected to the second subregion of the same cooling region, so that the second subregion is arranged upstream of the first subregion of the same cooling region, and a respective third subregion is fluidically connected to the fourth subregion of the same cooling region connected, so that the third subregion is arranged upstream of the fourth subregion. The cooling channels comprised by the first subregion can simply be fluidically coupled to the cooling channels of the second subregion of the same cooling region. In particular, these cooling channels of the same cooling region can be understood as different cooling channel sections of the same cooling channel passing through the first and second subregions. It is also conceivable to provide multiple cooling channels extending parallel to one another per cooling region. The same also applies to the third and fourth subregions. This means that the third and fourth subregions of a respective cooling region are also fluidically connected to one another.

According to a further advantageous embodiment of the invention, the first and in particular the fourth subregions are assigned a first main flow direction and the second and in particular also the third subregions are assigned a second main flow direction, which is opposite to the first main flow direction.

This makes it particularly easy to design the structure of the subregions and the cooling plate arrangement as such. The main flow directions can extend essentially parallel to the third direction. The coolant thus flows, for example, first into the second subregion and through it along the main flow direction and thus across all cells of the cell module. At the end of the cell module opposite to the first or second end region, the coolant can be introduced from the second subregion into the first subregion, for example via a deflection channel section, and flow back again in the opposite direction, namely the second main flow direction, across all cells of the same cell module. The same also applies similarly to the third and fourth subregions.

The main flow direction in particular designates a direction in which the coolant flows at least on average or primarily when flowing through the relevant subregions. The cooling channels assigned to the respective subregions do not necessarily have to extend exclusively parallel to this main flow direction, but can theoretically, although less preferably, extend in a wave shape or zigzag shape or the like. In addition, when redirecting from the second to the first subregion and in particular also from the third to the fourth subregion, the coolant is guided in a direction that is not parallel to one of the main flow directions, but essentially perpendicular thereto.

According to a further advantageous embodiment of the invention, the distributor arrangement has a supply distributor device which provides the at least one supply connection and which has a main supply connection for supplying a coolant to the supply distributor device, and a collection distributor device which provides the at least one discharge connection and which has a main discharge connection for discharging a coolant from the collection distributor device, in particular wherein the supply distributor device provides multiple supply connections fluidically connected to the cooling plate arrangement and the collection distributor device provides multiple discharge connections fluidically connected to the cooling plate arrangement.

This means that the supply and discharge of the coolant can be made particularly efficient. The supply distributor device and the collection distributor device can be located on the same side of the battery modules, in particular on the side of the battery modules on which the two end regions are also arranged in relation to the first energy storage arrangement. If the energy storage device has multiple such energy storage arrangements, they are arranged adjacent to one another in the second direction in such a way that the end regions of the cell groups of the second energy storage arrangement are also arranged adjacent to the end regions of the two cell groups of the first energy storage arrangement in relation to the second direction.

The distributor arrangement can therefore basically be divided into a supply distributor device and a collection distributor device. These can be provided, for example, in the form of pipes, hoses, corrugated pipes, or the like. Each of these distributor devices can in turn comprise a main connection, namely a main supply connection and a main discharge connection. Here the coolant is supplied centrally to the cooling device, for example by means of a coolant pump, and discharged therefrom again. In general, the cooling device of the energy storage device is connected to a closed cooling circuit of the motor vehicle in which the energy storage device is used. In such a closed cooling circuit, the coolant is circulated for the purpose of cooling the cell groups. The coolant therefore passes through the cooling device, is discharged from it again, cooled and supplied back to the cooling device, and so on.

The coolant discharged from the cooling plate arrangement is introduced into the collection distributor device via the multiple discharge connections and is accordingly collected by it and discharged again from the main discharge connection.

This enables a particularly advantageous, simple, and space-efficient structure of the distributor arrangement. It is also to be noted here that a supply connection or discharge connection does not necessarily have to be assigned separately to each subregion of the cooling plate arrangement. For example, some subregions can be coupled to a common supply connection and/or some subregions can be coupled to a common discharge connection. This is particularly suitable for subregions arranged adjacent to one another with respect to the second direction, for example the two second subregions of the first cooling unit and/or the two fourth subregions of the second cooling unit. This provides a large amount of flexibility with regard to the design of the cooling plates.

According to a further embodiment of the invention, the first cooling unit represents the only cooling unit for cooling the first and second cell groups. This applies at least to the first energy storage arrangement and optionally to every further energy storage arrangement. In other words, it can be provided that the cell groups arranged adjacent to one another in the second direction are only cooled on one side, namely only on the first side by the first cooling unit. Very significant advantages are also displayed here due to the positioning of the supply connection according to the invention in relation to the module connector, since the second poles also represent the somewhat more strongly cooled poles in this case. This also advantageously allows the temperature input caused by the module connector to be at least partially compensated for.

Furthermore, the invention also relates to a motor vehicle having an energy storage device according to the invention or one of its embodiments.

The motor vehicle according to the invention is preferably designed as an automobile, in particular as a passenger car or truck, or as a passenger bus or motorcycle.

The invention can also be used in stationary energy storage devices, that is to say the energy storage device according to the invention and its embodiments can also be a stationary energy storage device, which is therefore not installed in a motor vehicle.

Furthermore, the invention also relates to a method for cooling a first and second cell group of an energy storage device according to the invention or one of its embodiments. The coolant is supplied to the cooling plate arrangement via the distributor arrangement and the coolant flows through the second subregion of the first cooling region before it flows through the first subregion of the first cooling region. The coolant also flows through the second subregion of the third cooling region before it flows through the first subregion of the third cooling region.

The advantages described in relation to the energy storage device according to the invention and its embodiments apply in the same way to the method according to the invention.

The invention also includes refinements of the method according to the invention, which have features as have already been described in conjunction with the refinements of the energy storage device according to the invention. For this reason, the corresponding refinements of the method according to the invention are not described again here.

The invention also comprises the combinations of the features of the described embodiments. The invention therefore also comprises implementations that each have a combination of the features of several of the described embodiments, provided that the embodiments have not been described as mutually exclusive.

### BRIEF DESCRIPTION OF THE FIGURES

Exemplary embodiments of the invention are described hereinafter. In the figures:

FIG. 1 shows a schematic cross-sectional representation of an energy storage device according to an exemplary embodiment of the invention;

FIG. 2 shows a schematic representation of an energy storage device in a top view without cooling units shown according to a further exemplary embodiment of the invention.

FIG. 3 shows a schematic representation of a part of an energy storage device having a module connector according to an exemplary embodiment of the invention; and

FIG. 4 shows a schematic cross-sectional representation through a battery cell of an energy storage device according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also refine the invention independently of one another and are thus also to be considered to be part of the invention individually or in a combination other than that shown. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

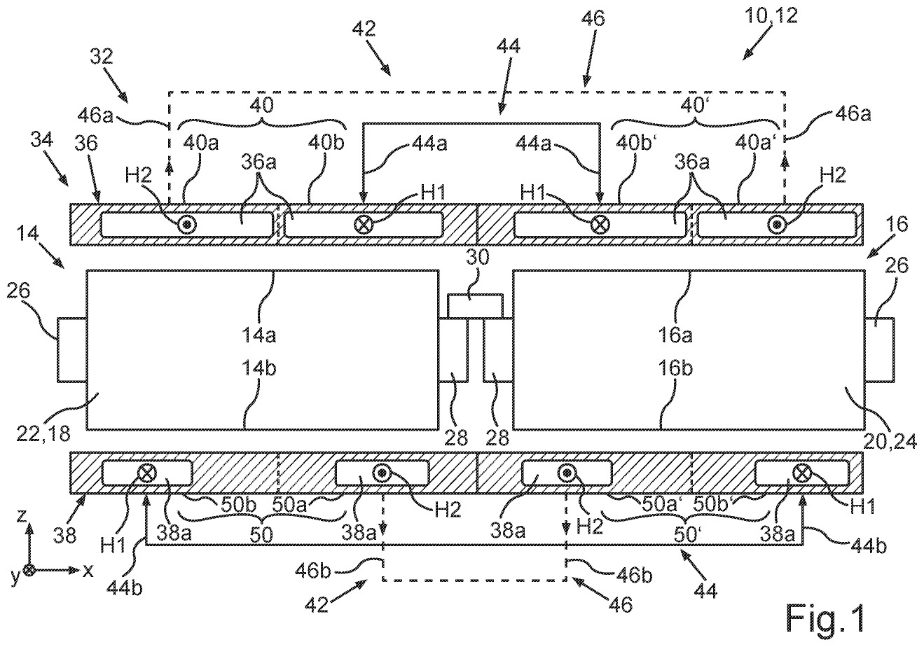

FIG. 1 shows a schematic representation of an energy storage device 10 according to an exemplary embodiment of the invention. In particular, a first energy storage arrangement 12 of such an energy storage device 10 is shown here. The energy storage device 10 has a first cell group 14 in the form of a first battery module 14, as well as a second cell group 16, which is also designed as a battery module 16 in this example. Each of these two battery modules 14, 16 comprises multiple battery cells 18, 20 arranged adjacent to one another in a stacking direction. The stacking direction corresponds to the y-direction shown. The two battery cells 18, 20 shown represent in particular two edge cells of the respective battery modules 14, 16, which therefore represent the first or last battery cell 18, 20 of the relevant battery module 14, 16 with respect to the y direction. The first battery cell 18 is therefore arranged in a first end region 22 of the first battery module 14, and the second battery cell 20 of the second battery module 16 in a second end region 24. The first end region 22 and the second end region 24 are arranged adjacent to one another in the x direction shown. Furthermore, the first battery cell 18 has two cell poles, namely a first cell pole 26 and a second cell pole 28 Likewise, the second battery cell 20 has a first cell pole 26 and a second cell pole 28. The second cell poles 28 are electrically conductively connected to one another via a module connector 30. The two battery modules 14, 16 can be connected in series, for example, via this module connector 30. Particularly in the region of such a module connector 30, a very large amount of heat arises during operation of the energy storage device 10. Since the module connector 30 is made of electrically conductive material and is connected to the electrically conductive second poles 28 of the two cells 18, 20, this heat is transferred to the poles 28 and is introduced accordingly into the respective battery cell 18, 20. Particularly in the region of the second poles 28, a hotspot region of the two cells 18, 20 thus arises, in particular without countermeasures or cooling.

The energy storage device 10 now advantageously has a cooling device 32 which is able to at least partially homogenize the inhomogeneous temperature distribution within a respective cell 18, 20 caused by the module connector 30. For this purpose, the cooling device 32 has a cooling plate arrangement 34, which comprises at least a first cooling unit 36. In this example, this first cooling unit 36 is designed as a primary cooling unit 36, since in this example the cooling plate arrangement 34 also has a second cooling unit 38.

The first battery module 14 has a first side 14a and a second side 14b opposite to the first side 14a with respect to the z direction. Likewise, the second battery module 16 has a first side 16a and a second side 16b that is opposite with respect to the z direction. The first cooling unit 36 is now arranged in relation to the battery modules 14, 16 in such a way that it is arranged on the first sides 14a, 16a of the respective battery modules 14, 16 or is connected thereto, for example via a thermally conductive compound. The second cooling unit 38, on the other hand, is arranged on the second sides 14b, 16b of the battery modules 14, 16. The first cooling unit 36 is thus arranged as an upper-side cooling plate and the second cooling unit 38 as a lower-side cooling plate. The first cooling unit 36 has first cooling channels 36a through which a coolant can flow, and the second cooling unit 38 has corresponding second cooling channels 38a, through which a coolant can also flow.

As a primary cooling unit, the first cooling unit 36 can provide a greater cooling capacity, for example per battery module 14, 16, than the second cooling unit 38, which can accordingly also be referred to as a secondary cooling unit. The greater cooling capacity of the first cooling unit 36 can be implemented, for example, by a larger cross-sectional area of the cooling channels 36a in relation to the cross-sectional area of the cooling channels 38a of the second cooling unit 38, as shown in this example.

The first cooling unit 36, as well as the second cooling unit 38, can now be divided once again into multiple regions. On the one hand, the first cooling unit 36 has a first cooling region 40 assigned to the first battery module 14 and a third cooling region 40′ assigned to the second battery module 16. The first cooling region 40 is again divided into a first subregion 40a and a second subregion 40b. The third cooling region 40′ is also divided into a first subregion 40a′ and a second subregion 40b′. These subregions 40a, 40b, 40a′, 40b′ are arranged in relation to the x direction shown in such a way that the second subregions 40b, 40b′ are arranged between the first two subregions 40a, 40a′. The subregions 40a, 40b of the first cooling region are arranged accordingly on the first side 14a of the first battery module 14, and the subregions 40a′, 40b′ of the third cooling region 40′ are arranged on the first side 16a of the second battery module 16.

The cooling device 32 now also has a distributor arrangement 42, which comprises a supply distributor device 44 for supplying a coolant to the cooling plate arrangement 34 and a collection distributor device 46. The distributor arrangement 42 can also be referred to as a coolant distributor. The supply distributor device 44 in turn comprises at least one supply connection, in this case multiple supply connections, wherein the supply connections coupled to the first cooling unit 36 are designated by 44a and the supply connections coupled to the second cooling unit 38 are designated by 44b. The collection distributor device 46 also has at least one discharge connection, in the present case multiple discharge connections 46a, 46b, wherein the discharge connections connected to the first cooling unit 36 are designated by 46a and the discharge connections connected to the second cooling unit 38 are designated by 46b.

The coolant can therefore be supplied to the first cooling unit 36, and in particular also to the second cooling unit 38, as explained in more detail later, via the at least one supply connection 44a, 44b, and the coolant can be discharged again from the first cooling unit 36, and in particular also from the second cooling unit 38, via the discharge connection 46a, 46b or several discharge connections 46a, 46b . The individual subregions 40a, 40b, 40a′, 40b′ are now embodied as follows: On the one hand, the first subregion 40a and the second subregion 40b of the first cooling section 40 are fluidically connected to one another. Likewise, the first subregion 40a′ and the second subregion 40b′ of the third cooling region 40′ are fluidically connected to one another. The coolant supply via the supply connection 44a is carried out to the respective second subregions 40b, 40b′. For example, the at least one supply connection 44a can be connected directly to a connection point of the respective second subregion 40b, 40b′. The coolant is therefore supplied, for example, to the second subregion 40b of the first cooling region 40, flows through this second subregion 40b in a first main flow direction H1, which in this example is aligned parallel to the y direction shown, and is then deflected, for example, at the end of the first cooling unit 36 in the y direction into the first subregion 40a and flows through it in a second main flow direction H2, which is opposite to the first main flow direction H1 and is accordingly aligned here counter to the y direction shown. The coolant flows through the first subregion 40a accordingly in turn to the end region of the cooling unit 36 in relation to the y direction and is then discharged again from the cooling unit 36 via the at least one discharge line 46, i.e., the collection distributor device 46. Similarly, the coolant is also supplied to the second subregion 40b′ of the third cooling region 40′ via the at least one supply line 44, i.e., the supply distributor device 46, or to the at least one supply connection 44a, flows through the second subregion 40b′ in the first main flow direction H1, is redirected accordingly at the end of the first cooling unit 36 into the first subregion 40a′ and flows in the second main flow direction H2 back to the beginning of the first cooling unit 36 and is accordingly discharged from the first cooling unit 36 again via the at least one discharge line 46 or the at least one discharge connection 46a. The first cooling region 40 and the third cooling region 40′ are moreover not fluidically connected to one another.

The great advantage of this design of the cooling device 32 is that the coolant is supplied to the second regions 40b, 40b′ of the first cooling unit 36, which are closer to the second poles 28, which are electrically conductively connected to one another via the module connector 30, than the first subregions 40a, 40a′. The background is that the coolant is typically significantly cooler at the time of supply to the first cooling unit 36 than after passing through the first cooling unit 36 at the time of discharge of the coolant from the first cooling unit 36. Accordingly, the second poles 28 or the cells 18, 24 in the region of their second poles 28 are cooled more strongly by the significantly colder coolant than in the region of the first poles 26, which are located closer to the first subregions 40a, 40a′, and through which warmer coolant accordingly flows. Especially in the region of the module connector 30, the cells 18, 24 heat up significantly more strongly. This can now advantageously be at least partially compensated for by the increased cooling in this region. By way of the design of the cooling device 32 and in particular by way of the skilled positioning of the supply connections 44a and the cooling channel guide, the stronger heating of the cells 18, 24 in the region of the module connector 30 can now advantageously also be taken into consideration. Overall, this results in a significantly more homogeneous temperature distribution within the cells 18, 24. This homogeneous temperature distribution can also be promoted by a suitable design of the second cooling unit 38. This second cooling unit 38 can also be divided into multiple regions. The second cooling unit 38 comprises a second cooling region 50 and a fourth cooling region 50′. The second cooling region 50 is in turn divided into a third subregion 50b and a fourth subregion 50a. Accordingly, the fourth cooling region 50′ is also divided into a third subregion 50b′ and a fourth subregion 50a′. The second cooling region 50 is again assigned to the first battery module 14 and the fourth cooling region 50′ is spatially assigned to the second battery module 16. Accordingly, the second cooling region 50 is arranged on the second side 14b of the first battery module 14 or connected thereto via a thermally conductive compound, for example, and the fourth cooling region 50′ is arranged on a second side 16b of the second battery module 16 or connected thereto via a thermally conductive compound or a thermal interface material.

In addition, the corresponding subregions are now connected to the supply line 44 and the discharge line 46 as follows: The supply connection 44b is connected to the respective third subregions 50b, 50b′, so that the coolant is supplied to these third subregions 50b, 50b′ first, before flowing through these subregions 50b, 50b′ into the corresponding fourth subregions 50a, 50a′ fluidically connected to these subregions 50b, 50b′ and discharged from the second cooling unit 38 again via the discharge line 46 or the discharge connection 46b. When supplied into the third subregions 50b, 50b′, the coolant flows through them again in the first main flow direction H1 and correspondingly flows back through the fourth subregions 50a, 50a′ in the second main flow direction H2. The second cooling region 50 is in turn fluidically separated from the fourth cooling region 50′. The third and fourth subregions 50b, 50a of the second cooling region 50 are fluidically connected to one another and the third and fourth subregions 50b′, 50a′ of the fourth cooling region 50′ are fluidically connected to one another. The coolant flowing through the second subregion 50 thus does not flow through the fourth cooling region 50′, at least not before it is cooled again in the cooling circuit and supplied again to the second cooling unit 38. With regard to the second cooling unit 38, the coolant supply now advantageously takes place via the external subregions 50b, 50b′ and not via the internal subregions 50a, 50a′. The coolant supply and discharged of the second cooling unit 38 is therefore designed diagonally or crossed to that of the first cooling plate 36. This crossed arrangement of the coolant supply and discharge promotes a homogeneous temperature distribution and a homogeneous cooling of the cells 18, 24 and all other cells of the modules 14 and 16.

In addition, it is conceivable that the energy storage device 10 has multiple such energy storage arrangements 12 described, which are arranged adjacent to one another in or counter to the x direction. In other words, in order to provide a larger energy storage device 10, multiple such energy storage arrangements 12 can simply be arranged adjacent to one another in an identical manner in the x direction or counter to the x direction. A respective energy storage arrangement 12 is designed to be mirror-symmetrical with respect to a central plane, which extends in the x direction through the middle of the two battery modules 14, 16 and is aligned perpendicular to the x direction, with respect to the design of the cooling plate arrangement 34 and in particular the coolant supply and discharge.

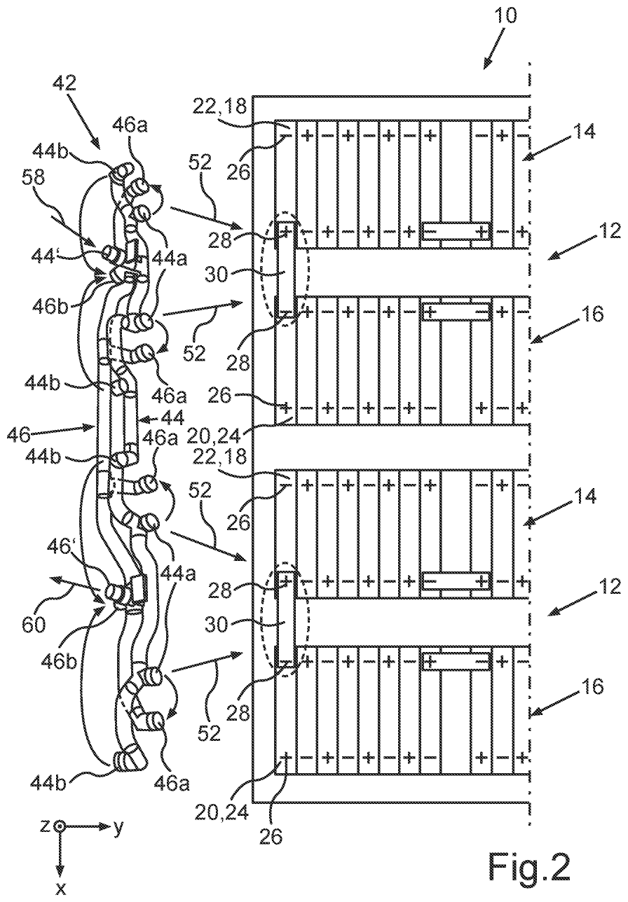

FIG. 2 shows once again a schematic representation of an energy storage device 10, in particular without a cooling plate arrangement 34 shown, having two energy storage arrangements 12 arranged adjacent to one another in the x direction according to an exemplary embodiment of the invention. Furthermore, the distributor arrangement 42 for the coolant supply and discharge is also shown again. The energy storage device 10, in particular the energy storage arrangements 12, are shown in a top view of the z direction.

The distributor arrangement 42 is shown in more detail here. In this exemplary embodiment, this comprises a supply line 44 and a discharge line 46. The supply line 44 is now connected to the first and second cooling units 36, 38 via multiple connections 44a, 44b. The supply connections for the first cooling unit 36 are again designated by 44a and the supply connections for the second cooling unit 38 are designated by 44b. In the present case, only the coolant supply for the first cooling plate 36 is illustrated by the arrows 52. The supply connections 44a can thus be supplied as described to the respective second subregions 40b, 40b′ of the respective energy storage arrangements 12, as described above.

The lower side, i.e., the second cooling unit 38, can be implemented as a cooling plate having four paths, wherein two paths share a return path. In other words, for the lower plate 38 there are four inlet connections 44b and two return connections 46b. The upper side, i.e., the first cooling unit 36, is implemented as a module cooling system, in which each cooling module, i.e., each cooling region 40, 40′, has its own connections for supply and return paths. In this example, four inlet connections 44a are provided, as well as four return connections 46a. The crossing inlets or outlets of the cooling connections for the upper and lower plates 36, 38 can also be clearly seen here. On the side of the coolant distributor 42 shown on the right, the arrows 52 point to the inflow of cold cooling water to the modules 14, 16 and thus to the first cells 18, 20 in the modules 14, 16, to which the high-voltage cross-connectors 30 are attached.

The coolant supply to the first cooling unit 36, in particular to the cooling unit having the higher cooling capacity, thus advantageously takes place in the area of the module connector 30, so that the increasingly strong heat development in this region can be compensated for very well. The supply line 44 can have a main supply connection 44′, in particular in this example a single main supply connection 44′ to supply the coolant to the distributor arrangement 42. After the coolant has passed through the first cooling unit, it is discharged via the corresponding discharge connections 46a into the discharge line 46 as part of the distributor arrangement 42. This discharge line 46 has a main discharge connection 46′, via which the coolant can then be discharged again from the distributor arrangement 42. The arrow 58 marks the inflow of the cold coolant from the vehicle side and the arrow 60 marks the coolant return on the vehicle side. The coolant, which has passed through the second cooling unit 38, can also be supplied back to the discharge line 46 via appropriate connections 46b and discharged via the main discharge connection 46′. The coolant is then circulated in the cooling circuit, at the same time cooled again and returned to the distributor arrangement 42 via the main supply connection 44′.

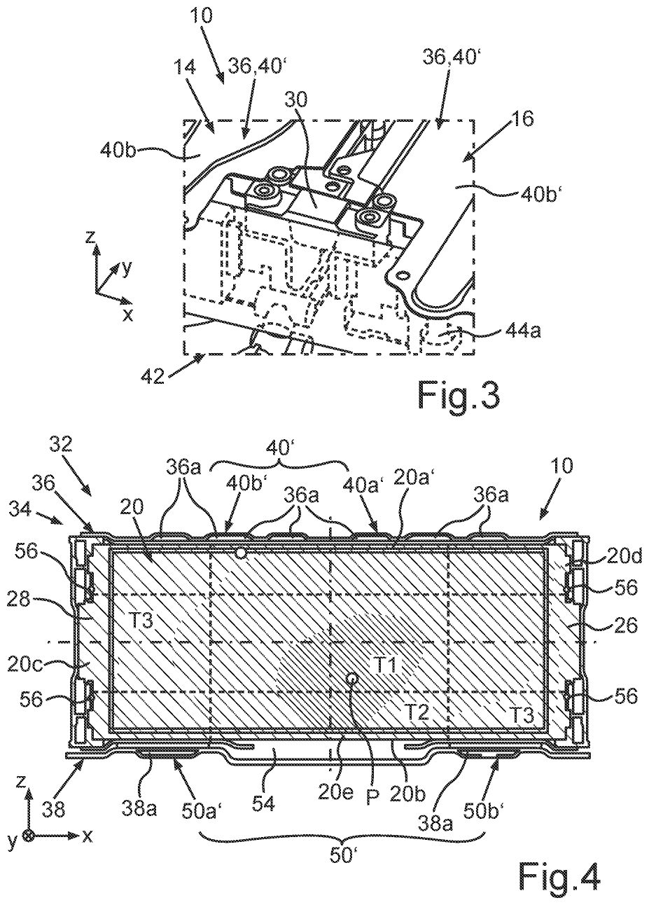

FIG. 3 again shows a schematic and perspective detailed representation of a part of an energy storage device 10 in the region of a module connector 30, which contacts two second cell poles 28 of two battery modules 14, 16 with one another. The battery modules 14, 16 are shown in a top view obliquely from above, so that a part of the first cooling plate 36 arranged thereon can be seen in the present case, in particular the first cooling region 40 and the third cooling region 40′ associated with the second module 16. In addition, a connection 44a of the distributor arrangement 42, which is connected to the second subregion 40b′ of the third cooling section 40′, can also be seen. FIG. 3 illustrates the implementation of the high-voltage cross-connector 30, i.e., the module connector 30, in the high-voltage storage system 10 with the connection to the spatially first cells 18, 20 in the system, against which the cold coolant flows directly.

FIG. 4 shows a schematic cross-sectional illustration of a cross section through the second battery cell 20 in the end region 24 of the battery module 16 according to one exemplary embodiment of the invention. The battery cell 20 in turn has the two cell poles 26, 28, one of which is designed as a positive cell pole and the other as a negative cell pole. The cell poles 26, 28 are advantageously arranged here on the sides 20c, 20d of the cell 20, which are different from an upper side 20a and a lower side 20b of the cell 20. This enables very efficient cooling on both sides of such a battery cell 20 in a particularly advantageous manner, and which are also different from a front and rear side of the cell 20, which delimit the cell in and counter to the stacking direction y.

To cool the battery cell 20, the energy storage device 10, as already described, comprises the cooling device 32 having the cooling plate arrangement 34, which comprises the first cooling unit 36 and the second cooling unit 38. Of these, in the present case in particular only the third cooling region 40′ and the fourth cooling region 50′ having the respective subregions 40a′, 40b′, 50a′, 50b′ are shown here. The corresponding cooling channels extending through these subregions are designated by 36a, 38a. A venting opening 20e is also arranged on the lower side 20b of the battery cell 20. This can also be provided on the lower sides of all other battery cells of the energy storage device 10. This venting opening 20e represents a releasable degassing opening, which can be implemented, for example, in the form of a bursting membrane and from which gases arising in the event of a thermal runaway of such a battery cell 20 can escape from such a battery cell 20. In order to facilitate the escape of gas downward, the cooling channels 38a in the third and fourth subregions 50a′, 50b′ accordingly have a greater distance in the x direction to one another than, for example, the cooling channels 36a of the first cooling unit 36. Thus, a free region 54 can be provided directly below the venting opening 20e.

The described design of the cooling device 32 now advantageously results in a particularly homogeneous temperature distribution across the cell 20. To better illustrate this homogeneous temperature distribution, different temperature ranges T1, T2, T3 are now also shown in FIG. 4, wherein the first temperature range T1 represents the range having the highest temperature, for example, approximately 38.3° C., the second temperature range T2 represents a region having lower temperature, and the temperature range T3 represents a region having the lowest temperature in the present case. This can be, for example, 15° C. Temperature sensors for detecting such a temperature profile are also designated by 56. P also designates the position of the local temperature maximum.

Overall, the examples show how the invention can provide a system arrangement for the thermodynamic integration of module connectors of a high-voltage storage system. The invention makes it possible to design high-voltage cross-connectors in a relatively compact design and to arrange them in the region of the cooling. The connections of the high-voltage connectors are placed where the coolant flow having the greatest possible temperature gradient hits the front cells—i.e., near the cold water connections of the cooling plates. In other words, the cold water connections of the cooling plates are placed near the module connectors. This allows cold water to flow specifically through the interface between the cell and the module connector. In this way, the thermal energy arising due to the transport of the high currents is conducted into the modules, onto the cell, where it advantageously encounters the lowest temperatures in the entire module. This in turn results in a more homogeneous temperature distribution across the entire battery, which has a positive effect on the temperature balance and, as a result, on the overall performance of the storage, for example charging time, performance, and so on. Above all, the uniform thermal load equalizes the aging of all cells and thus increases the lifespan of the entire battery.

1. An energy storage device comprising: a first and second cell group and having a cooling device for cooling at least the first and second cell group,
wherein the energy storage device has a first energy storage arrangement which comprises the first and second cell groups, each of which has a first side a second side opposite to the first side with respect to a first direction,
wherein the first and second cell groups are arranged adjacent to one another with respect to a second direction,
wherein the first cell group has a first end region with respect to a third direction, in which a first battery cell of the first cell group is arranged, which has a first cell pole and a second cell pole, wherein the second cell pole of the first battery cell of the second cell group is located closer than the first cell pole of the first battery cell;
wherein the second cell group has a second end region with respect to the third direction, in which a second battery cell of the second cell group is arranged, which has a first cell pole and a second cell pole, wherein the second cell pole of the second battery cell of the first cell group is located closer than the first cell pole of the second battery cell;
wherein the first end region is located adjacent to the second end region with respect to the second direction;
wherein the first energy storage arrangement has a module connector which electrically conductively connects the second cell pole of the first battery cell and the second cell pole of the second battery cell to one another;
wherein the cooling device, as part of the first energy storage arrangement, has a cooling plate arrangement having a first cooling unit through which a coolant can flow and which is arranged on the first sides of the first and second cell groups; and
wherein the cooling device has a distributor arrangement which has at least one supply connection fluidically coupled to the first cooling unit for supplying a coolant to the first cooling unit and has at least one discharge connection fluidically coupled to the first cooling unit for discharging the coolant supplied to the first cooling unit from the first cooling unit;
wherein the first cooling unit has a first cooling region, which is assigned to the first cell group and which is divided with respect to the second direction into a first subregion through which the coolant can flow and a second subregion through which the coolant can flow;
the first cooling unit has a third cooling region, which is assigned to the second cell group and which is divided with respect to the second direction into a first subregion through which the coolant can flow and a second subregion through which the coolant can flow; and
wherein the second two subregions are arranged in relation to the second direction between the first two subregions and are coupled to the at least one supply connection, and the first two subregions are coupled to the at least one discharge connection, so that the second subregions are located closer to the at least one supply connection than the first subregions with respect to an intended flow direction.

2. The energy storage device according to claim 1,
wherein the cooling plate arrangement has a second cooling unit through which a coolant can flow and which is arranged on the second sides of the first and second cell groups,
wherein the second cooling unit has a second cooling region, which is assigned to the first cell group and which is divided with respect to the second direction into a third subregion through which the coolant can flow and a fourth subregion through which the coolant can flow,
wherein the first subregion of the first cooling region is opposite to the third subregion with respect to the first direction and the second subregion of the first cooling region is opposite to the fourth subregion with respect to the first direction, and
wherein the second and third subregions are coupled to the at least one supply connection, and the first and fourth subregions are coupled to the at least one discharge connection, so that the second and third subregions are located closer to the at least one supply connection in the flow direction than the first and fourth subregions.

3. The energy storage device according to claim 2, wherein the second cooling unit per cell group has a lower cooling capacity than the first cooling unit per cell group.

4. The energy storage device according to claim 2,
wherein the second cooling unit has a fourth cooling region, which is assigned to the second cell group and which is divided with respect to the second direction into a third subregion through which the coolant can flow and a fourth subregion through which the coolant can flow,
wherein the first subregion of the third cooling region is opposite to the third subregion of the fourth cooling region with respect to the first direction and the second subregion of the third cooling region is opposite to the fourth subregion of the fourth cooling region with respect to the first direction, and
wherein the second subregion of the third cooling region and the third subregion of the fourth cooling region are coupled to the at least one supply connection, and the first subregion of the third cooling region and the fourth subregion of the fourth cooling region are coupled to the at least one discharge connection, so that the second and third subregions are closer to the at least one supply connection in the flow direction than the first and fourth subregions.

5. The energy storage device according to claim 1, wherein the energy storage device has a second energy storage arrangement, which is designed like the first energy storage arrangement and is arranged in the second direction adjacent to the first energy storage arrangement.

6. The energy storage device according to claim 5, wherein a respective first subregion is fluidically connected to the second subregion of the same cooling region, so that the second subregion is arranged upstream of the first subregion of the same cooling region, and a respective third subregion is fluidically connected to the fourth subregion of the same cooling region, so that the third subregion is arranged upstream of the fourth subregion of the same cooling region.

7. The energy storage device according to claim 1, wherein the first and the fourth subregions are assigned a first main flow direction and the second and, in particular, the third subregions are assigned a second main flow direction, which is opposite to the first main flow direction.

8. The energy storage device according to claim 1, wherein the distributor arrangement has a supply distributor device which provides the at least one supply connection and which has a main supply connection for supplying a coolant to the supply distributor device, and a collection distributor device which provides the at least one discharge connection and which has a main discharge connection for discharging a coolant from the collection distributor device, in particular wherein the supply distributor device provides multiple supply connections fluidically connected to the cooling plate arrangement and the collection distributor device provides multiple discharge connections fluidically connected to the cooling plate arrangement.

9. The energy storage device according clam 1, wherein the first cooling unit represents the only cooling unit for cooling the first and second cell groups.

10. A method for cooling a first and second cell group of an energy storage device according to claim 1, comprising:
the coolant is supplied to the cooling plate arrangement via the distributor arrangement, and
the coolant flows through the second subregion of the first cooling region before it flows through the first subregion of the first cooling region and
the coolant flows through the second subregion of the third cooling region before it flows through the first subregion of the third cooling region.

11. The energy storage device according to claim 3, wherein the second cooling unit has a fourth cooling region, which is assigned to the second cell group and which is divided with respect to the second direction into a third subregion through which the coolant can flow and a fourth subregion through which the coolant can flow,
wherein the first subregion of the third cooling region is opposite to the third subregion of the fourth cooling region with respect to the first direction and the second subregion of the third cooling region is opposite to the fourth subregion of the fourth cooling region with respect to the first direction, and
wherein the second subregion of the third cooling region and the third subregion of the fourth cooling region are coupled to the at least one supply connection, and the first subregion of the third cooling region and the fourth subregion of the fourth cooling region are coupled to the at least one discharge connection, so that the second and third subregions are closer to the at least one supply connection in the flow direction than the first and fourth subregions.

12. The energy storage device according to claim 2, wherein the energy storage device has a second energy storage arrangement, which is designed like the first energy storage arrangement and is arranged in the second direction adjacent to the first energy storage arrangement.

13. The energy storage device according to claim 3, wherein the energy storage device has a second energy storage arrangement, which is designed like the first energy storage arrangement and is arranged in the second direction adjacent to the first energy storage arrangement.

14. The energy storage device according to claim 4, wherein the energy storage device has a second energy storage arrangement, which is designed like the first energy storage arrangement and is arranged in the second direction adjacent to the first energy storage arrangement.

15. The energy storage device according to claim 2, wherein the first and the fourth subregions are assigned a first main flow direction and the second and, in particular, the third subregions are assigned a second main flow direction, which is opposite to the first main flow direction.

16. The energy storage device according to claim 3, wherein the first and the fourth subregions are assigned a first main flow direction and the second and, in particular, the third subregions are assigned a second main flow direction, which is opposite to the first main flow direction.

17. The energy storage device according to claim 4, wherein the first and the fourth subregions are assigned a first main flow direction and the second and, in particular, the third subregions are assigned a second main flow direction, which is opposite to the first main flow direction.

18. The energy storage device according to claim 5, wherein the first and the fourth subregions are assigned a first main flow direction and the second and, in particular, the third subregions are assigned a second main flow direction, which is opposite to the first main flow direction.

19. The energy storage device according to claim 6, wherein the first and the fourth subregions are assigned a first main flow direction and the second and, in particular, the third subregions are assigned a second main flow direction, which is opposite to the first main flow direction.

20. The energy storage device according to claim 2, wherein the distributor arrangement has a supply distributor device which provides the at least one supply connection and which has a main supply connection for supplying a coolant to the supply distributor device, and a collection distributor device which provides the at least one discharge connection and which has a main discharge connection for discharging a coolant from the collection distributor device, in particular wherein the supply distributor device provides multiple supply connections fluidically connected to the cooling plate arrangement and the collection distributor device provides multiple discharge connections fluidically connected to the cooling plate arrangement.
